(19) United States
(12) Patent Application Publication
(10) Pub. No.: US 2023/0057554 A1
(43) Pub. Date: Feb. 23, 2023

(54) DISTANCE MEASUREMENT SYSTEM

(71) Applicant: Hitachi-LG Data Storage, Inc., Tokyo (JP)

(72) Inventors: Tsukasa TAKAHASHI, Tokyo (JP); Katsuhiko IZUMI, Tokyo (JP)

(21) Appl. No.: 17/863,534

(22) Filed: Jul. 13, 2022

(30) Foreign Application Priority Data
Aug. 18, 2021 (JP) 2021-133626

(51) Int. Cl. G01S 17/894; G01J 5/00

(52) U.S. Cl. CPC G01S 17/894; G01J 5/0025

(57) ABSTRACT

A distance measurement system according to the invention includes a processor, a distance measurement device, and a heat detection device. In the distance measurement system, the distance measurement device can measure a distance to a subject and can generate a distance image related to the subject whose distance has been measured. The heat detection device can measure the temperature of the subject and can generate a temperature image related to the subject whose temperature has been measured. The processor can associate the distance image and the temperature image acquired from the same point of view and determine whether or not the subject is an object on the basis of a distance value and a temperature value at the same position in the images.

### CROSS-REFERENCE TO RELATED APPLICATION

The present application claims priority from Japanese application JP2021-133626, filed on Aug. 18, 2021, the contents of which is hereby incorporated by reference into this application.

### BACKGROUND OF THE INVENTION

### 1. Field of the Invention

The present invention relates to a distance measurement system.

### 2. Description of the Related Art

In the related art, in some cases, a distance measurement device is used to detect an object. Here, JP No. 2014-149761 A discloses a technique that suppresses erroneous detection of a person.

That is, JP No. 2014-149761 A discloses an information processing device (PC) that is provided with a temperature sensor and a distance measurement sensor for detecting the presence of a user. A temperature sensor element is attached to an electronic substrate of the temperature sensor. The temperature sensor element detects the temperature of an object present in a detection target area. Therefore, the temperature sensor detects the temperature of a target object that faces a display screen of the PC in a non-contact manner. The distance measurement sensor can measure the distance to the user or the object facing the display screen of the PC and can detect the presence or absence of the user. Then, the information processing device determines that the object is the body of the user of the information processing device when the distance to the object measured by the distance measurement sensor is less than a predetermined distance threshold value and the temperature of the object detected by the temperature sensor is greater than a predetermined temperature threshold value.

However, it is considered that only the simple threshold value determination may not suffice for the accuracy of detecting the object.

### SUMMARY OF THE INVENTION

Therefore, an object of the invention is to provide a distance measurement system that can ensure good object detection accuracy.

According to the invention, the following distance measurement system is provided. The distance measurement system includes a processor, a distance measurement device, and a heat detection device. The distance measurement device measures a distance and generates a distance image. The heat detection device measures a temperature and generates a temperature image. The processor associates the distance image and the temperature image acquires from the same point of view and determines whether or not a subject is an object on the basis of a distance value and a temperature value at the same position in the images.

According to the invention, it is possible to provide a distance measurement system that can ensure good object detection accuracy.

### BRIEF DESCRIPTION OF THE DRAWINGS

FIG. 1 is a diagram illustrating an example of a hardware configuration of a distance measurement system;

FIG. 2 is a diagram illustrating an example of a distance image generated by a three-dimensional distance measurement device;

FIG. 3 is a diagram illustrating an example of a temperature image generated by a heat detection terminal;

FIG. 4 is a flowchart illustrating an example of a process of an object detection program;

FIG. 5 is a diagram illustrating an example of an association image in which the distance image and the temperature image have been associated with each other;

FIG. 6 is a diagram illustrating an example of object detection based on distance data;

FIG. 7 is a diagram illustrating the distance dependence of a temperature value acquired by a temperature sensor; and

FIG. 8 is a diagram illustrating an example of the use of the distance measurement system.

### DETAILED DESCRIPTION OF THE PREFERRED EMBODIMENTS

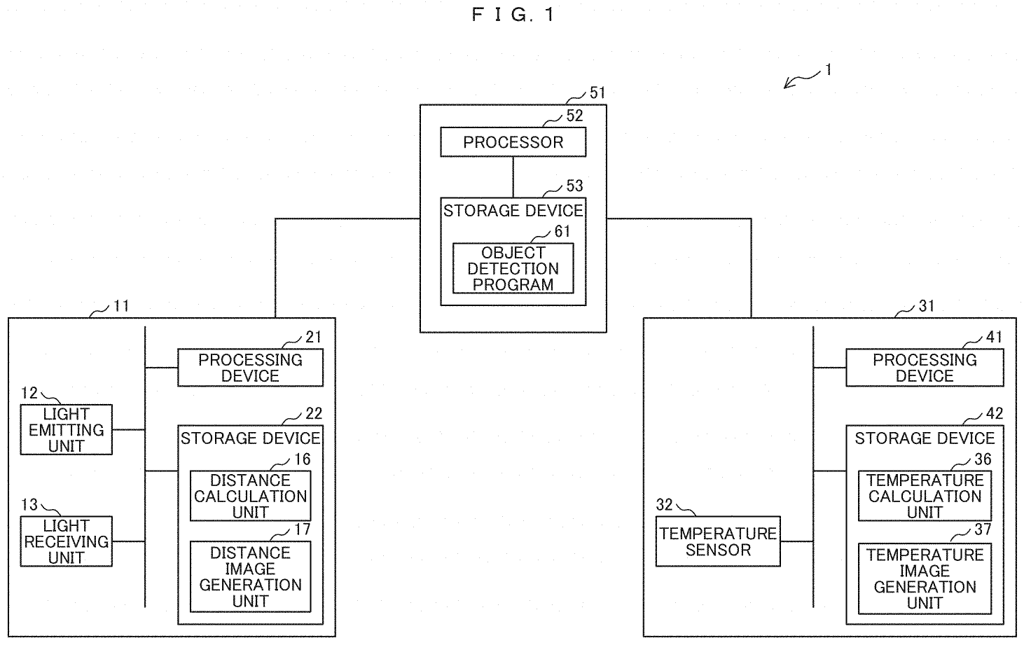

An embodiment of the invention will be described with reference to the drawings. FIG. 1 is a diagram illustrating an example of a hardware configuration of a distance measurement system. As illustrated in FIG. 1, a distance measurement system 1 includes a three-dimensional distance measurement device 11 (distance measurement device), a heat detection terminal 31 (heat detection device), and a personal computer 51 (PC).

In this embodiment, the three-dimensional distance measurement device 11 and the heat detection terminal 31 are disposed so as to perform measurement from the same point of view. In addition, the three-dimensional distance measurement device 11, the heat detection terminal 31, and the PC 51 include interfaces (not illustrated). Then, the PC 51 can acquire data from the three-dimensional distance measurement device 11 and the heat detection terminal 31 through the interface and perform data processing.

First, the three-dimensional distance measurement device 11 will be described in detail. The three-dimensional distance measurement device 11 is a device that can measure the distance to a subject and generate a distance image I1 and is a TOF sensor in this embodiment. The TOF sensor measures the distance on the basis of so-called time of flight (TOF). The three-dimensional distance measurement device 11 includes a light emitting unit 12, a light receiving unit 13, a distance calculation unit 16, and a distance image generation unit 17.

The light emitting unit 12 emits pulsed irradiation light emitted by a light source such as a laser diode (LD) or a light emitting diode (LED). The light receiving unit 13 receives pulsed reflected light which has been reflected and returned, using an image sensor, such as a CCD or a CMOS, in which pixels two-dimensionally are arranged and converts the pulsed reflected light into an electric signal.

The distance calculation unit 16 calculates the distance to the subject from an output signal of the light receiving unit 13. The distance image generation unit 17 generates the distance image I1, in which the distance to the subject is expressed in color, on the basis of the calculated distance. For example, the distance image generation unit 17 can generate an image that becomes closer to red as the distance to the subject becomes shorter and becomes closer to blue as the distance to the subject becomes longer (for convenience, the distance is shown in grayscale in the drawings).

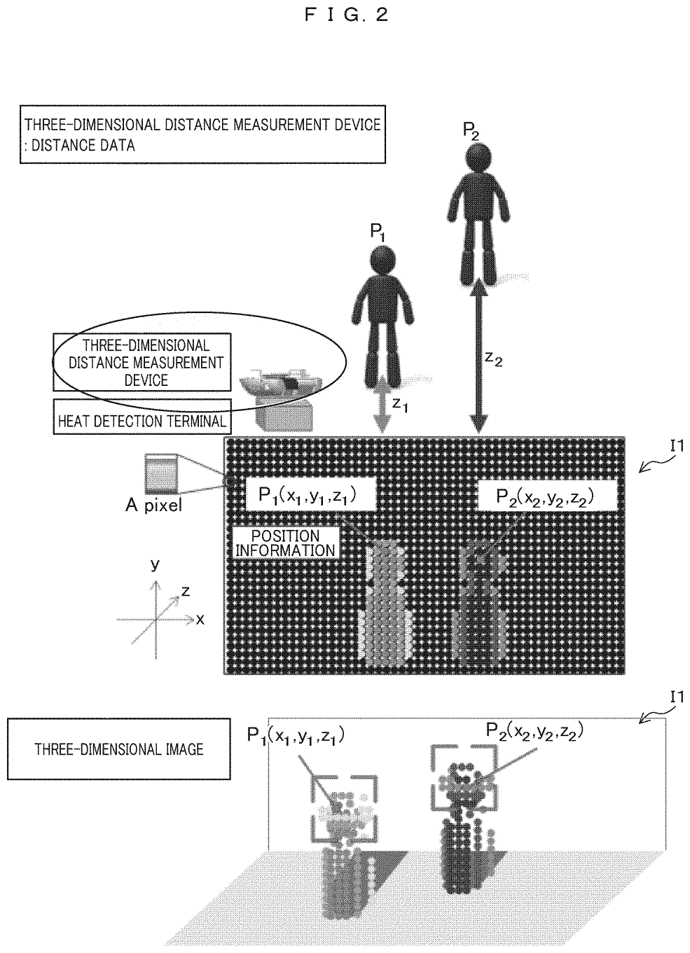

Here, the distance image I1 generated by the three-dimensional distance measurement device 11 will be described in detail with reference to FIG. 2. FIG. 2 is a diagram illustrating an example of the distance image generated by the three-dimensional distance measurement device.

The irradiation light is emitted from the light emitting unit 12 of the three-dimensional distance measurement device 11, and the light receiving unit 13 receives reflected light which has been reflected from a subject P1 and a subject P2 located in a measurement direction (that is, the direction of the point of view from the three-dimensional distance measurement device 11). Then, the distance calculation unit 16 calculates the distances to the subject P1 and the subject P2, and the distance image generation unit 17 generates the distance image I1 including color pixels corresponding to the distances. Further, in this example, the subject P2 is farther than the subject P1. Therefore, in this example, in the distance image I1, the subject P2 is represented by a color indicating a position that is farther than the subject P1. Specifically, in this example, the subject P2 is represented in blue, and the subject P1 is represented in green. Furthermore, a difference between distance values to each part of the subject (that is, an uneven shape of the subject) is expressed by colors from a difference in the light receiving timing at the pixel positions of the image sensor.

In addition, the subject P1 is located on the left side of the subject P2. Therefore, in the distance image I1, the subject P1 is displayed on the left side of the subject P2. Here, in the distance image I1, when a right-left direction is the x direction, an up-down direction is the y direction, and a distance z is considered by the colors of the pixels, the subject P1 at a distance z1 is displayed at a position (x1, y1) in the distance image I1, and the subject P2 at a distance z2 is displayed at a position (x2, y2) in the distance image I1.

The distance image I1 of the two-dimensional image has been described above. However, the distance image generation unit 17 may generate the distance image I1 of a three-dimensional image corresponding to the two-dimensional image. In the three-dimensional image, the subject is represented by a point group, and the distance to the subject is represented by the color of the point group. In this example, the subject P1 is represented in green, and the subject P2 is represented in blue as in the case of the two-dimensional image.

Further, the distance calculation unit 16 and the distance image generation unit 17 of the three-dimensional distance measurement device 11 are programs, and these processes are performed by an appropriate processing device 21 (for example, a CPU) included in the three-dimensional distance measurement device 11. Furthermore, the three-dimensional distance measurement device 11 may include other programs (for example, a program related to motion control). The three-dimensional distance measurement device 11 may include an appropriate storage device 22 (for example, a ROM) that stores data such as programs. In addition, the three-dimensional distance measurement device 11 may include a RAM that temporarily stores data at the time of data processing.

Next, the heat detection terminal 31 will be described in detail. The heat detection terminal 31 is a device that can measure the temperature of the subject in a non-contact manner and generate a two-dimensional image of the temperature of the subject. The heat detection terminal 31 includes a temperature sensor 32, a temperature calculation unit 36, and a temperature image generation unit 37.

The temperature sensor 32 is a sensor used to measure temperature and can be a known non-contact-type sensor. The temperature sensor 32 acquires, for example, information on the intensity of infrared rays emitted from an object.

The temperature calculation unit 36 calculates the temperature of the subject from an output signal of the temperature sensor 32. The temperature image generation unit 37 generates a two-dimensional temperature image 12 in which the temperature T of the subject (Temp in the drawings) is expressed in color on the basis of the calculated temperature. For example, the temperature image generation unit 37 can generate an image that becomes closer to red or white as the temperature becomes higher and becomes closer to blue or black as the temperature becomes lower (for convenience, the image is shown in grayscale in the drawings).

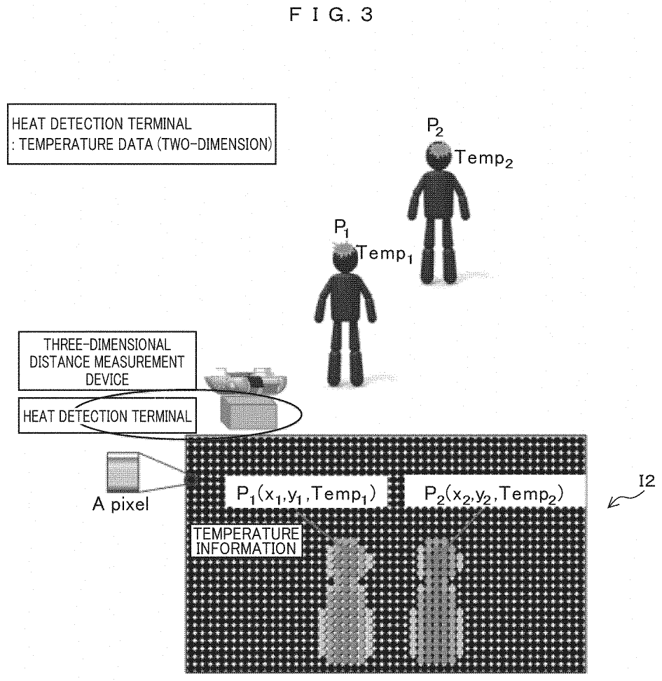

Here, the temperature image I2 generated by the heat detection terminal 31 will be described in detail with reference to FIG. 3. FIG. 3 is a diagram illustrating an example of the temperature image generated by the heat detection terminal.

The heat detection terminal 31 measures the temperature of the subject P1 and the subject P2 from, for example, infrared rays emitted from the subject P1 and the subject P2 located in the measurement direction (that is, the direction of the point of view of the heat detection terminal 31). Here, the temperature image generation unit 37 generates the temperature image I2 including color pixels corresponding to the temperature. In addition, in this example, since the same temperature is measured from the subject P1 and the subject P2, the subject P1 and the subject P2 are represented by the same color in the temperature image 12.

The subject P1 and the subject P2 are measured at the same place as that in the case of the three-dimensional distance measurement device 11. Then, as described above, since the three-dimensional distance measurement device 11 and the heat detection terminal 31 perform measurement from the same point of view, the subject P1 and the subject P2 in the temperature image 12 are displayed at the same positions as the distance image I1. That is, in the temperature image 12, when a right-left direction is the x direction, an up-down direction is the y direction, and the temperature T is considered in color, the subject P1 at a temperature T1 (Temp1) is displayed at a position (x1, y1) corresponding to that in the distance image I1, and the subject P2 at a temperature T2 (Temp2) is displayed at a position (x2, y2) corresponding to that in the distance image I1.

In addition, the temperature calculation unit 36 and the temperature image generation unit 37 are programs, and these processes are performed by an appropriate processing device 41 (for example, a CPU) included in the heat detection terminal 31. Further, the heat detection terminal 31 may be any device as long as it can appropriately generate the temperature image 12 and may include, for example, a camera. Then, the heat detection terminal 31 may generate the temperature image 12 using image data acquired by the camera. Furthermore, the heat detection terminal 31 may include other programs (for example, a program related to motion control). The heat detection terminal 31 may include an appropriate storage device 42 (for example, a ROM) that stores data such as programs. Further, the heat detection terminal 31 may include a RAM that temporarily stores data at the time of data processing.

The PC 51 can be a general computer and includes a processor 52 and a storage device 53. The processor 52 may be any device that can mainly perform a predetermined process and can be, for example, a CPU. The processor 52 may be other semiconductor devices (for example, a GPU). The storage device 53 can store data used for processes and can be an appropriate device such as a ROM. In addition, the PC 51 may include a RAM that temporarily stores data at the time of data processing. In this embodiment, the processor 52 executes an object detection program 61 to determine whether or not the subject is an object.

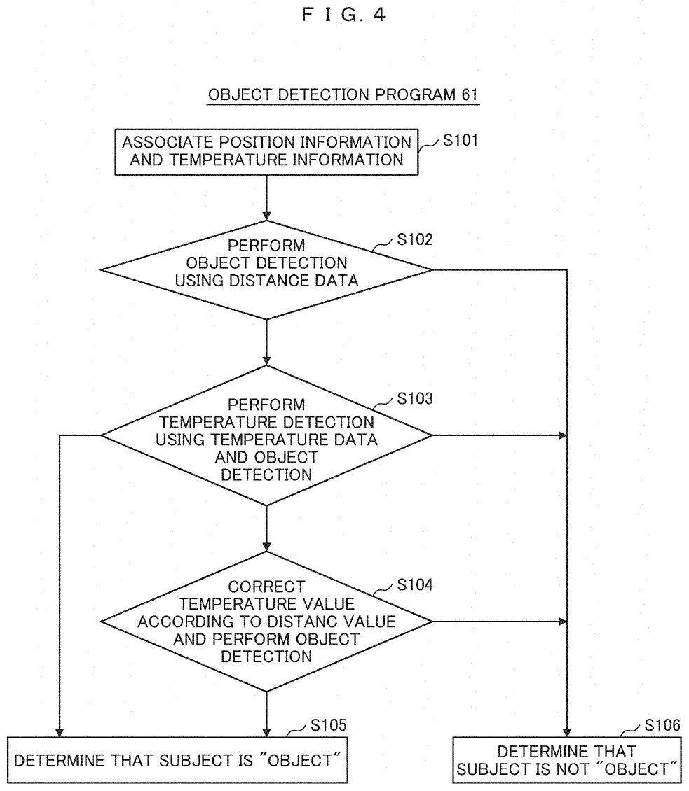

Next, the process of the object detection program 61 will be described. FIG. 4 is a flowchart illustrating an example of the process of the object detection program. In this embodiment, the processor 52 of the PC 51 mainly performs the process of the object detection program 61.

In the execution of the object detection program 61, first, distance data as position information and temperature data as temperature information are acquired from the three-dimensional distance measurement device 11 and the heat detection terminal 31 acquire, and the process is performed while associating the distance data with the temperature data (S101). In Step 101, for example, the distance image I1 that includes a distance value and serves as the position information and the temperature image 12 that includes a temperature value and serves as the temperature information may be acquired, and the process may be performed while associating these data items to generate an association image 13 in which the distance image I1 and the temperature image 12 have been associated with each other.

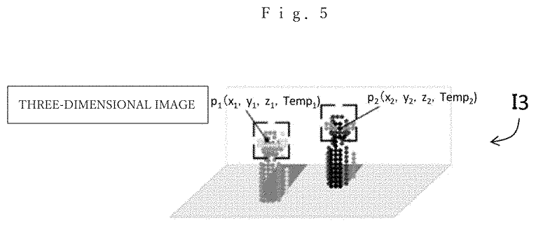

For example, the association image 13 of a three-dimensional image illustrated in FIG. 5 may be generated. In the association image 13, the shape of the subject is shown by representing the subject with a point group in the same way as in the distance image I1 of the three-dimensional image. In addition, the association image 13 includes the temperature information of the subject based on the acquired temperature image 12. In addition, the example in which the three-dimensional image is generated as the association image 13 has been described. However, in Step 101, the association image 13 of a two-dimensional image may be generated. In the association image 13 of the two-dimensional image, the shape of the subject is shown by the pixels indicating the subject, and the association image 13 includes the temperature information of the subject based on the acquired temperature image 12.

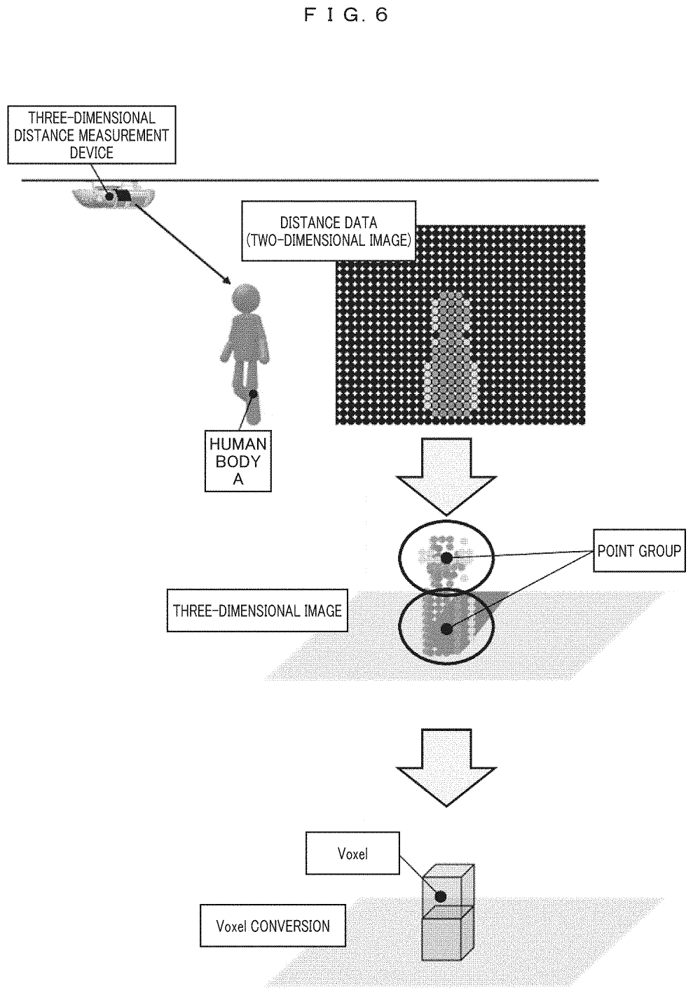

Next, object detection using distance data is performed (S102). Here, an example of the object detection in Step 102 will be described in detail with reference to FIG. 6. FIG. 6 is a diagram illustrating an example of the object detection using the distance data.

As illustrated in FIG. 6, in a case in which a three-dimensional image is used, a portion of a point group, in which a distance value is output, in the three-dimensional image is treated as a voxel group, and a portion in which two or more voxels are vertically arranged is detected as an object. Here, for example, the size of one voxel is set to 20×20×20 cm with respect to the size of the subject. However, the size of the voxel may be appropriately changed, for example, in consideration of the general size of the subject as a target.

In addition, the portion in which two or more voxels are vertically arranged may be detected as an object on the basis of the movement distance and movement speed of the portion. Further, the voxel may be formed so as to include a predetermined number or more of point groups. Here, the number of point groups included in the voxel may be determined according to the distance value.

Here, the object detection based on the three-dimensional image has been described. However, object detection based on a two-dimensional image may be performed. In a case in which a two-dimensional image is used, for example, an aggregated portion with a size equal to larger than a predetermined size (or larger than the predetermined size) among the aggregated portions of the pixels in which the distance value is output may be detected as an object.

In a case in which an object is detected in Step 102, a process in Step 103 is performed. On the other hand, in a case in which no object is detected in Step 102, it is not determined that the subject is an object (S106).

Then, temperature detection based on temperature data is performed, and an object is detected (S103). That is, in Step 103, it is determined whether or not the temperature of the portion in which the object has been detected in Step 102 is within a predetermined range.

Then, in a case in which the temperature of the portion, in which the object has been detected in Step 102, within the predetermined range is detected, the object is detected, and the portion (that is, the detected subject) is determined to be an object (S105). On the other hand, in a case in which the temperature within the predetermined range is not detected, the portion is not determined to be an object (S106). In addition, it may be determined whether or not the temperature of the entire portion in which the object has been detected in Step 102 is within the predetermined range, or it may be determined whether or not the temperature of a part of the portion is within the predetermined range.

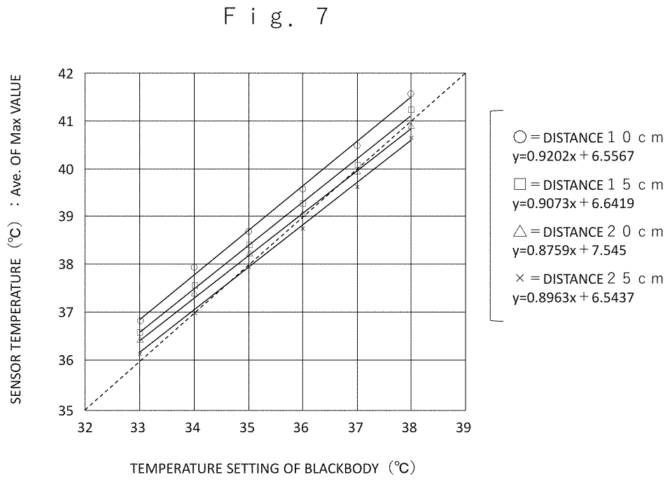

Further, the temperature measured by the temperature sensor 32 depends on the distance to the subject. That is, as illustrated in FIG. 7, the temperature sensor measures the temperature of the subject higher than the actual temperature as a distance value to a target (blackbody in FIG. 7) becomes smaller. Therefore, the temperature measured by the heat detection terminal 31 in Step 103 may be corrected according to the distance value (S104). Then, in Step 104, object detection may be performed on the basis of whether or not the temperature value corrected according to the distance value is within a predetermined range, and object determination may be performed. In addition, the data used for the correction (for example, as illustrated in FIG. 7, the data in which the distance value and the temperature value are associated with each other) can be prepared in advance in, for example, the storage device 53 of the PC 51.

In Step 102, the process based on the association image I3 acquired in Step 101 may be performed. That is, the process may be performed on the portion in which the distance value is output in the association image 13. In addition, the process may be performed on the portion in which the distance value is output in the distance image I1 acquired from the three-dimensional distance measurement device 11 instead of the association image 13.

Further, in Step 103, the process based on the association image I3 acquired in Step 101 may be performed. That is, in Step 103, the temperature of the portion in which the object has been detected in Step 102 may be acquired from the association image 13, and it may be determined whether or not the temperature value is within a predetermined range. In addition, the temperature of the portion in which the object has been detected in Step 102 may be acquired from the temperature image I2 acquired from the heat detection terminal 31 instead of the association image 13, and it may be determined whether or not the temperature value is within a predetermined range. Further, similarly, the temperature to be corrected in Step 104 may be acquired.

In a case in which the association image 13 is not used in the processes related to Steps 102 to 104 (that is, in a case in which the subject to be determined to be an object is detected from the pixels or the point group having the distance value of the distance image I1 and it is determined whether or not the temperature value is within a predetermined temperature range), the process of generating the association image 13 may be omitted in Step 101.

According to the process of the object detection program 61, an object is detected by the object detection process, and it is determined whether or not the object has a temperature value within a predetermined range, which makes it possible to determine whether or not the subject is an object with high accuracy.

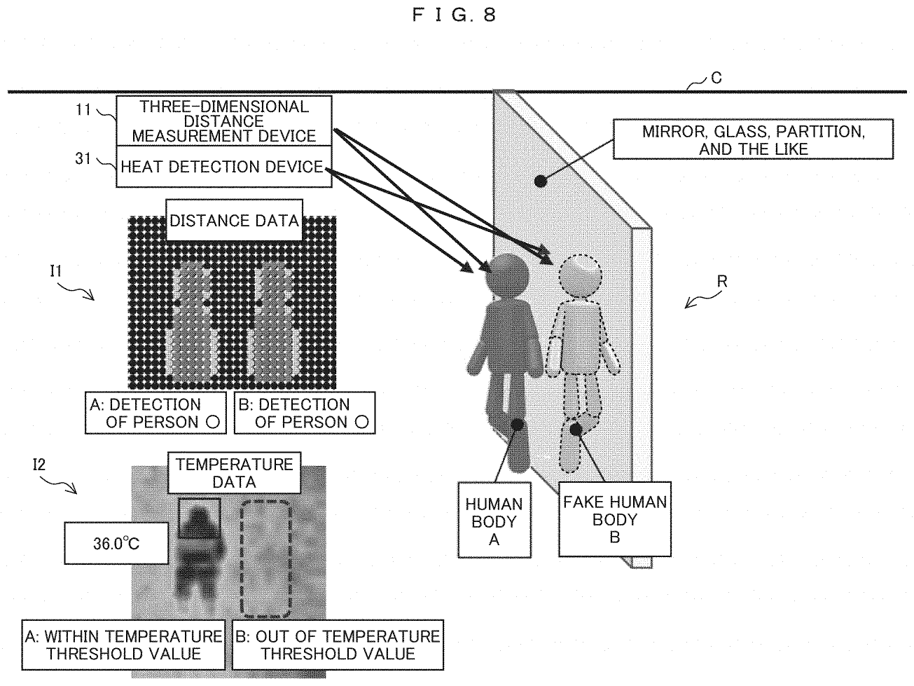

Next, an example of the use of the distance measurement system 1 will be described with reference to FIG. 8. In this example, the three-dimensional distance measurement device 11 is installed on a ceiling C of a room and measures a target area. Further, the heat detection terminal 31 is provided in a lower part of the three-dimensional distance measurement device 11 (for example, fixed to the lower part of the three-dimensional distance measurement device 11) and measures the target area from the same point of view as the three-dimensional distance measurement device 11. The PC 51 may acquire data from the three-dimensional distance measurement device 11 and the heat detection terminal 31. For example, the PC 51 may be disposed in the same room and may acquire data using wired communication. In addition, the PC 51 may be disposed at, for example, an external remote location and may acquire data using wireless communication.

The three-dimensional distance measurement device 11 can measure the distance to the subject by emitting the irradiation light and receiving the reflected light from the subject and generate the distance image I1. Here, when the subject is located near an object with high reflectance (for example, a mirror, glass, a transparent partition, or the like, which is referred to as a reflector R in some cases), light used for measurement may be reflected from the reflector R. In this case, the three-dimensional distance measurement device 11 receives the light reflected from the reflector R. Then, the three-dimensional distance measurement device 11 erroneously detects a fake subject reflected from the reflector R. As a result, the three-dimensional distance measurement device 11 may output distance data including the fake subject. That is, the three-dimensional distance measurement device 11 may calculate a distance value related to the fake subject and generate the distance image I1 including the fake subject. Therefore, in this environment, it is difficult to ensure good object detection accuracy only by performing measurement with the three-dimensional distance measurement device 11.

For this reason, the distance measurement system 1 according to this embodiment acquires the temperature image 12 corresponding to the distance image I1 from the heat detection terminal 31 and determines an object on the basis of the distance value and the temperature value at the same position in the images. Therefore, it is possible to suppress the erroneous detection of an object and to ensure good object detection accuracy.

In addition, in this example, since the subject is the human body, it is possible to determine whether or not the subject is an object on the basis of whether the temperature value to be measured is within a temperature range (for example, 35° C. to 40° C.) corresponding to the human body. That is, in a case in which the subject is determined to be the human body (person), the temperature range can be set within a range corresponding to the human body temperature. However, the subject may be objects other than the human body. The temperature range corresponding to the subject may be appropriately set, and the determination may be performed on the basis of this temperature range.

Data processing is performed only on the subject determined to be an object and is not performed on the subject determined not to be an object, which makes it possible to improve the accuracy of movement trace and people counting. Here, for example, the movement trace and the people counting can be performed using an appropriate application. For example, the processor 52 of the PC 51 may perform a process, in which the object detection program 61 and an application have been associated with each other, to perform the process related to the movement trace and the people counting.

The invention is not limited to the above-described embodiment and includes various modification examples. For example, the above-described embodiment has been described in detail for a better understanding of the invention and is not necessarily limited to those including all of the configurations of the description. In addition, according to this embodiment, there is provided a distance measurement method using the processor 52, a distance measurement device (the three-dimensional distance measurement device 11) that measures a distance and generates the distance image I1, and a heat detection device (heat detection terminal 31) that measures temperature and generates the temperature image 12. The processor 52 associates the distance image I1 and the temperature image I2 acquired from the same point of view and determines whether or not a subject is an object on the basis of a distance value and a temperature value at the same position in the images.

The distance measurement system 1 may include a plurality of three-dimensional distance measurement devices 11 and a plurality of heat detection terminals 31 and perform a process using data acquired from these devices. Here, the three-dimensional distance measurement devices 11 and the heat detection terminals 31 are appropriately disposed such that each pair thereof performs measurement from the same point of view. Then, in the execution of the object detection program 61, the processor 52 may determine whether or not the subject is an object on the basis of data acquired from each of the pairs of the three-dimensional distance measurement devices 11 and the heat detection terminals 31.

In the above description, the PC 51 includes the storage device 53. However, any configuration may be used as long as the processor 52 can perform a predetermined process, and the processor 52 may acquire data from the outside (for example, an external storage device) and perform the process. In this case, the storage device 53 of the PC 51 may be omitted.

In the above description, an example using the PC 51 has been described. However, any configuration may be used as long as a predetermined process can be implemented by the processor 52, and other types of computers and the like may be used instead of the PC 51.

What is claimed is:

1. A distance measurement system comprising:
a processor;
a distance measurement device that measures a distance and generates a distance image; and
a heat detection device that measures a temperature and generates a temperature image,
wherein the processor associates the distance image and the temperature image acquired from the same point of view and determines whether or not a subject is an object on the basis of a distance value and a temperature value at the same position in the images.

2. The distance measurement system according to claim 1,
wherein the processor determines whether or not the temperature value is within a predetermined temperature range in the determination of the subject.

3. The distance measurement system according to claim 2,
wherein the processor detects the subject determined to be the object from a pixel or a point group having the distance value in the distance image.

4. The distance measurement system according to claim 2,
wherein the processor associates the distance image and the temperature image to generate an association image which is a three-dimensional image including a shape and temperature information of the subject.

5. The distance measurement system according to claim 2,
wherein the processor associates the distance image and the temperature image to generate an association image which is a two-dimensional image including a shape and temperature information of the subject.

6. The distance measurement system according to claim 4,
wherein the processor detects the subject determined to be the object from a point group of a distance value having a temperature value within a predetermined temperature range in the association image.

7. The distance measurement system according to claim 5,
wherein the processor detects the subject determined to be the object from each pixel of a distance value having a temperature value within a predetermined temperature range in the association image.

8. The distance measurement system according to claim 1,
wherein the processor corrects the temperature value according to the distance value and performs a process.

9. The distance measurement system according to claim 2,
wherein the processor corrects the temperature value according to the distance value and performs a process.

10. The distance measurement system according to claim 3,
wherein the processor corrects the temperature value according to the distance value and performs a process.

11. The distance measurement system according to claim 4,
wherein the processor corrects the temperature value according to the distance value and performs a process.

12. The distance measurement system according to claim 5,
wherein the processor corrects the temperature value according to the distance value and performs a process.

13. The distance measurement system according to claim 6,
wherein the processor corrects the temperature value according to the distance value and performs a process.

14. The distance measurement system according to claim 7,
wherein the processor corrects the temperature value according to the distance value and performs a process.

15. The distance measurement system according to claim 1,
wherein the heat detection device is provided in a lower part of the distance measurement device.

16. The distance measurement system according to claim 2,
wherein a temperature range in a case in which the subject is determined to be a person is set in a range equivalent to a human body temperature.
